(19) United States
(12) Patent Application Publication
(10) Pub. No.: US 2009/0164185 A1
(43) Pub. Date: Jun. 25, 2009

(54) METHOD OF MEASURING FLOW SECTIONS OF A TURBOMACHINE NOZZLE SECTOR BY DIGITIZING

(75) Inventor: Justine MENUEY, Chatellerault (FR)

Correspondence Address: OBLON, SPIVAK, MCCLELLAND MAIER & NEUSTADT, P.C., 1940 DUKE STREET, ALEXANDRIA, VA, 22314, US

(73) Assignee: SNECMA SERVICES, Paris (FR)

(21) Appl. No.: 12/340,980

(22) Filed: Dec. 22, 2008

(30) Foreign Application Priority Data
Dec. 24, 2007 (FR) 07 60334

(51) Int. Cl. G06G 7/64

(52) U.S. Cl. 703/7; 703/9

(57) ABSTRACT

A method of measuring flow sections of a turbomachine nozzle sector relative to two reference vanes, wherein:

a) a three-dimensional numerical model of the sector is produced by digitizing;

b) numerical models are provided for the two reference vanes;

c) the reference vanes are reset at the ends of the numerical model of the sector in their assembly relative positions in the nozzle; and

d) the flow sections of the sector are determined from sections of the numerical models of the sector and of the reference vanes;

the nozzle sector having contact surfaces, and being positioned relative to adjacent nozzle sectors by putting said contact surfaces into abutment, the numerical models of the sector and of the reference vanes including models of the contact surfaces involved in putting them into their assembly relative position, and step c) being performed by putting the contact surfaces into correspondence.

### FIELD OF THE INVENTION

The present invention relates to a method of measuring flow sections of a turbomachine nozzle sector. More generally, the invention relates to a method of selecting an arrangement of sectors for a turbomachine nozzle.

### BACKGROUND OF THE INVENTION

In a turbomachine nozzle, a sector is a known part that comprises one or more vanes interconnecting two platforms. The nozzle is essentially constituted by uniting sectors in a ring. In the nozzle, each sector is positioned in or takes up an assembly position relative to two adjacent sectors situated on either side thereof by means of contact surfaces of its platforms coming into abutment with contact surfaces of the platforms of the adjacent sectors.

The flow sections of a sector are the areas, measured perpendicularly to the stream flow direction, of the sections occupied by the stream(s) passing through the nozzle sector. By extension, the term “flow section” may also designate merely the width of the stream flowing through the nozzle sector.

Below, flow sections are considered in their proper meaning, i.e. relating to stream flow sections that are areas. But more generally, it can be understood that the present invention also applies to stream flow sections that are presented merely as the above-mentioned stream flow widths.

Amongst the stream flow sections in a nozzle sector, a distinction can be drawn between internal flow sections and external flow sections.

Internal flow sections are to be found only in nozzle sectors that have at least two vanes, and they are measured between vanes that are adjacent in pairs in the sector under consideration.

The two external flow sections are each half the area formed between an end vane of the sector and a so-called “reference” vane that is used for performing the measurement. The reference vane is or represents the facing vane of the adjacent sector in the nozzle. In principle, the area between the end vane of the nozzle sector and the reference vane needs to be determined using a reference vane that has nominal dimensions; this produces the nominal flow section for the corresponding end of the nozzle sector. By extension, it is possible to determine a real flow section for the end of the nozzle relative to a reference vane that forms part of a given sector; under such circumstances, the area between the end vane of the nozzle sector and the above-mentioned vane is determined, and the flow section for said end of the nozzle sector is half of said area.

In a nozzle, it is known that overall performance depends in particular on the flow sections of the nozzle, i.e. on the sum of the flow sections of its various sectors. Measuring these flow sections is therefore an important operation.

It should be observed in particular that during repair operations, which operations require the sectors of the nozzle to be cleaned and then resurfaced, the values of the flow sections are liable to change. At the end of such operations, it is therefore appropriate to re-measure the values of the flow sections of the nozzle in order to ensure that it remains in compliance with specified requirements.

In order to measure the flow section of a sector, two measurement methods are conventionally used.

Firstly it is possible to use a measurement bench on which the sector is placed and that allows a flow of air to be passed therethrough, with various magnitudes relating to the flow of air as it passes through the sector then being measured. On the basis of the way these magnitudes vary, it is possible to determine the flow sections of the sector.

Such a bench is used mainly for low-pressure nozzles. The measurement method as defined in this way suffers from the drawback of poor accuracy and of not enabling information to be obtained about the sectors other than their flow sections.

The second measurement method that is used for measuring the flow sections of nozzle sectors makes use of a measurement bench that is essentially mechanical.

Measurements are performed as follows: a nozzle sector is placed on the measurement bench between two reference vanes. The reference vanes are fixed vanes incorporated in the measurement bench. Once the sector has been positioned and locked in place, the operator applies a comparator provided with a feeler tip on various points on either side of the nozzle sector being measured, and also on the reference vanes incorporated in the assembly, so as to measure various points of the nozzle sector. As a general rule, the comparator used is of the multiple-dimension type, i.e. it measures simultaneously a plurality of dimensions, e.g. eight distance dimensions between a vane and an adjacent vane and also a distance dimension between the two opposite platforms of the nozzle sector, within the inter-vane channel, i.e. the passage between two adjacent vanes.

This second measurement method is used in particular for high-pressure nozzles. Although it is relatively simple to implement, it suffers from various drawbacks, and to begin with it lacks accuracy; in particular, the results obtained often depend on the operator making the measurement. Furthermore, those measurements produce only a relatively small number of data points concerning the part. As mentioned above, in conventional manner, using that measurement method at least ten distance measurements are taken between a vane and the adjacent vane, and often only one distance measurement is taken in the perpendicular direction between the two platforms of the nozzle sector.

### OBJECT AND SUMMARY OF THE INVENTION

A first object of the invention is to define a method of measuring the flow sections of a turbomachine nozzle sector relative to two reference vanes, which method provides increased accuracy, said sector having at least one vane, the method comprising the following steps:

a) producing a three-dimensional numerical model of the sector by digitizing;

b) providing the numerical models of each of two reference vanes;

c) resetting the numerical models of the two reference vanes at the ends of the sector in the assembly relative position in the nozzle; and

d) determining the flow sections of the sector from the sections of the numerical models of the sector and of the reference vanes.

This object is achieved by the fact that:

the nozzle sector has contact surfaces and is positioned relative to the adjacent nozzle sectors by putting said contact surfaces into abutment;

the numerical models of the sector and of the reference vanes include modeling the contact surfaces involving in putting them into their assembly relative position; and

step c) of resetting the numerical models of the reference vanes relative to the numerical model of the sector is performed by putting said contact surfaces into correspondence.

The term “digitizing” is used herein to mean any method of obtaining three-dimensional coordinates on the part, whether using mechanical means with a feeler tip or optical means using a laser scanner or structured light projection, for example, or indeed by photogrammetry. In any event, digitizing assumes that a large number of three-dimensional coordinates are taken so as to obtain a “cloud” of points, thus making it possible in particular to display the resulting numerical model in the form of a mesh on a computer screen.

The use of digitizing on parts such as nozzle sectors is an operation that is difficult, but nevertheless presents substantial advantages.

This operation is difficult firstly because of the shapes of the surfaces of a nozzle sector. A nozzle sector is a part of complex shape, presenting numerous skew surfaces, with the normals thereto being directed in all directions.

Furthermore, the surfaces that need to be measured in order to determine the flow sections of the sector are disposed on either side of the inter-vane channel. This channel is narrow, having a width of a few millimeters to a few centimeters; it is therefore difficult to insert a measurement tool into this space. Furthermore, in an inter-vane channel, the surfaces to be measured are surfaces that face one another, being disposed respectively on the pressure side of a vane and on the suction side of the adjacent vane, and also on the inside surfaces (i.e. surfaces beside the vane) of the two platforms of the sector.

Furthermore, it is necessary not only to measure the above-mentioned flow sections, but also during measurement to measure contact surfaces that are needed for referencing the resulting numerical model. The contact surfaces are generally oriented in a manner that is completely different from the surfaces that are to be measured. This gives rise to additional difficulty in measurement.

Finally, the level of accuracy expected of such measurements is high. The acceptable measurement uncertainty does not exceed one to a few hundredths of a millimeter.

For the reasons mentioned above, digitizing the nozzle sector is an operation that is difficult. That said, it should be observed that there is no need to digitize the outside surfaces of the sector in full. For a given flow section between two vanes, it is essential to digitize the facing surfaces of the vanes and of the two platforms, specifically in the smallest flow section for the stream in the inter-vane channel. Depending on the resetting method used, it can also be of use to digitize contact surfaces of the nozzle sector, i.e. surfaces that are used for positioning the sector relative to the sectors adjacent thereto in the nozzle. This point is developed below.

Conversely, digitizing provides a three-dimensional numerical model of the nozzle sector that contains a very large amount of information concerning it, i.e. an almost complete measurement of the outside shape of the nozzle sector. Use of this numerical model makes it possible in particular to determine the flow sections of the nozzle. This can be done more accurately than when making use of the few spot measurements that can be obtained by using a measurement bench, together with real measurement of an air flow or a mechanical measurement bench, as mentioned above. In addition, the numerical model also makes it possible to measure a large number of other dimensions relating to the nozzle sector, and more generally it makes it possible to measure and verify all of the design dimensions. It is thus possible to store this information in memory, to build up an extremely rich database, and enabling thorough traceability operations to be performed.

The method has an important step, in particular from the point of view of measurement accuracy, namely that of resetting the numerical model of the reference vanes relative to the end vanes of the nozzle sector being measured. (The term “resetting” is used herein to mean determining a change of three-dimensional frame of reference for application to a three-dimensional numerical model, so as to put it in a given position relative to another three-dimensional model. This can also be said to be “repositioning”).

To perform such resetting of the numerical models of the reference vanes relative to the numerical models of the measured sector, an alternative to the method of the invention might consist in performing resetting by the assembly bench, i.e. putting the reference vanes mechanically into position relative to the nozzle sector being measured. However, in the invention resetting is not implemented between mechanical parts, but is performed digitally in the computer between the numerical models for the reference vanes and the numerical model for the nozzle sector being measured.

Advantageously, the numerical resetting thus uses the same rules and thus provides the same results as would be provided by real resetting as could be performed between the measured nozzle sector and an adjacent nozzle sector.

It should also be observed that by resetting a set of nozzle sectors simultaneously, their flow sections (each relative to the two sectors that are adjacent in the sector arrangement under consideration) can all be determined together.

In an implementation, the reference vanes are portions of nozzle sectors. These nozzle sectors may either be standard nozzle sectors of dimensions that comply with the nominal dimensions of the sectors, or they may be other sectors of the nozzle as actually used in a turbomachine and relative to which it is desired to measure the flow sections of the nozzle sector being measured.

In general, the method of the invention makes it possible to omit the assembly bench or at least to use an assembly bench that is simpler. In this method, the nozzle sector is measured on its own without any special positioning relative to reference vanes or to other parts (which nevertheless does not prevent the use of means for fastening or holding the sector in place while the measurement is being performed).

In an implementation, the numerical model of the reference vanes provided in step b) is a theoretical numerical model of the vanes. The term “theoretical numerical model” is used herein to mean a model as generated by a computer, typically with the help of computer-assisted design (CAD) software; and this term is used in contrast to a model that is the result of digitizing. Advantageously, in this implementation, the reference vanes are not digitized every time it is necessary to determine the flow sections of a nozzle sector.

In an implementation, the numerical model of at least one of the reference vanes is obtained by digitizing at least one other nozzle sector. Under such circumstances, the measurement of the external flow section at the end in question of the nozzle sector is a relative measurement, performed relative to the other nozzle sector, presenting an end vane that constitutes one of the reference vanes used for the measurement.

The numerical models of the reference vanes are reset relative to the numerical model of the nozzle sector as follows. As specified above, the nozzle sector has contact surfaces and it is put into position relative to the adjacent nozzle sectors by bringing these contact surfaces into abutment.

In an implementation, digitizing step a) is performed with the help of contactless optical measurement means. The use of contactless measurement or optical measurement is particularly advantageous with nozzle sectors since it avoids any scratching of the part and any degradation of its surface.

In an implementation, digitizing is automated. This result can be obtained in particular by fitting the digitizing sensor, such as a 3D scanner with structured light projection, to the end of a robot arm. The robot arm follows a predetermined path including a certain number of stop positions. Whenever the arm stops in one of these stop positions, the digitizing sensor proceeds to acquire data. In known manner, the various acquisitions performed in the different stop positions are reset relative to one another automatically, by a computer, so as to constitute the three-dimensional numerical model of the digitized sector.

In an implementation, the steps of resetting and/or determining the flow sections are automated. The computer software used for performing steps c) to d) of resetting and of determining the flow sections is programmed to perform these operations in sequence without human intervention. The result obtained is an inspection report specifying the looked-for flow sections.

The advantages of automation are a saving in time, a reduction in operator error, a reduction in manpower time, and an increase in result reproducibility, ending up with better accuracy for the measurement method.

A second object of the invention is to remedy the above-mentioned drawbacks by defining a method of selecting an arrangement of sectors for a turbomachine nozzle, this method comprising the steps of:

A) creating a database of three-dimensional numerical models of the nozzle sectors by digitizing;

B) setting a criterion for selecting an arrangement of sectors and setting a desired value for said criterion, the criterion being a function of the flow sections of the sectors in their assembly relative positions in the arrangement;

C) for the various arrangements that are evaluated, determining the relative positions of the sectors assembled together by performing virtual assembly; then evaluating the flow sections of the sectors with the help of the above-described method of measuring nozzle sector flow sections, using as reference vanes for any one sector the facing vanes of the sectors that are adjacent in the arrangement, and on the basis of the resulting flow sections, determining the value of the selection criterion for the arrangement being evaluated; and

D) retaining the arrangement for which the selection criterion has the value closest to the desired value.

In the above, an arrangement of sectors for a turbomachine nozzle designates the ordered sequence of individual references for these sectors when assembled in a ring to form a nozzle. Thus, two arrangements differ when the positions of the sectors within the nozzle are not the same, for example if the sectors are subject to permutation. It should be observed that an arrangement of sectors may designate the ordered sequence of individual references of a set of sectors that do not make up an entire nozzle, but only a fraction thereof.

Furthermore, selecting an arrangement for a set of sectors involves firstly selecting the sectors that are to make up the arrangement, and also selecting the respective positions thereof within the arrangement.

The method of selecting a sector arrangement described above serves advantageously to optimize the sectors selected and their relative positions within a nozzle when building up the nozzle. It follows that a nozzle is obtained with improved performance and increased lifetime. Naturally, the method seeks more particularly to enable an arrangement to be selected for all of the sectors making up a complete nozzle. In addition, using a database of three-dimensional numerical models of the nozzle sectors enables a large number of geometrical characteristics of the nozzle sectors to be monitored and tracked simultaneously.

The criterion set in step B) can take different values depending on which constraints are judged to be the most important for optimizing the nozzle. For example, it is thus possible to seek to make the flow sections as similar to possible to one another in the nozzle, independently of their respective dimensions; etc.

In an implementation, in step C), at least one evaluated arrangement is the combination of an arrangement selected by the method plus another sector or another arrangement selected with the help of the method. The algorithm for assembling the nozzle is thus a recursive algorithm: the arrangement of sectors making up the nozzle is defined little by little, with each occasion involving optimizing the addition of a new nozzle sector to the existing arrangement.

Finally, a database of three-dimensional models of nozzle sectors can be used either to optimize assembling a single nozzle, or to optimize a set of nozzle sectors enabling a plurality of nozzles to be built up.

Thus, in this implementation, in step A), the database used for the method may contain sectors coming from a single nozzle, or it may contain sectors coming from at least two different nozzles.

### BRIEF DESCRIPTION OF THE DRAWINGS

The invention can be well understood and its advantages appear better on reading the following detailed description of implementations given as non-limiting examples. The description refers to the accompanying drawings, in which:

FIG. 1 is a perspective view of a bench for measuring a nozzle sector;

FIG. 2 is a perspective view of three nozzle sectors in the assembly relative position, their contact surfaces being put into contact by abutment;

FIG. 3 is a section view perpendicularly to the axis of the vanes in the assembly relative position, showing a measured sector and two adjacent sectors;

FIG. 4 is a section view of two adjacent sectors showing the section of the inter-vane channel in which a flow section between two adjacent vanes is measured; and

FIG. 5 is a face view of a set of nozzle sectors, in an arrangement that is optimized by the method of the invention for selecting and arrangement of nozzle sectors.

It should be observed that when an element appears in more than one of the figures, either identically or in analogous form, it is described with reference to the first figure in which it appears; furthermore, an element is described only once.

### MORE DETAILED DESCRIPTION

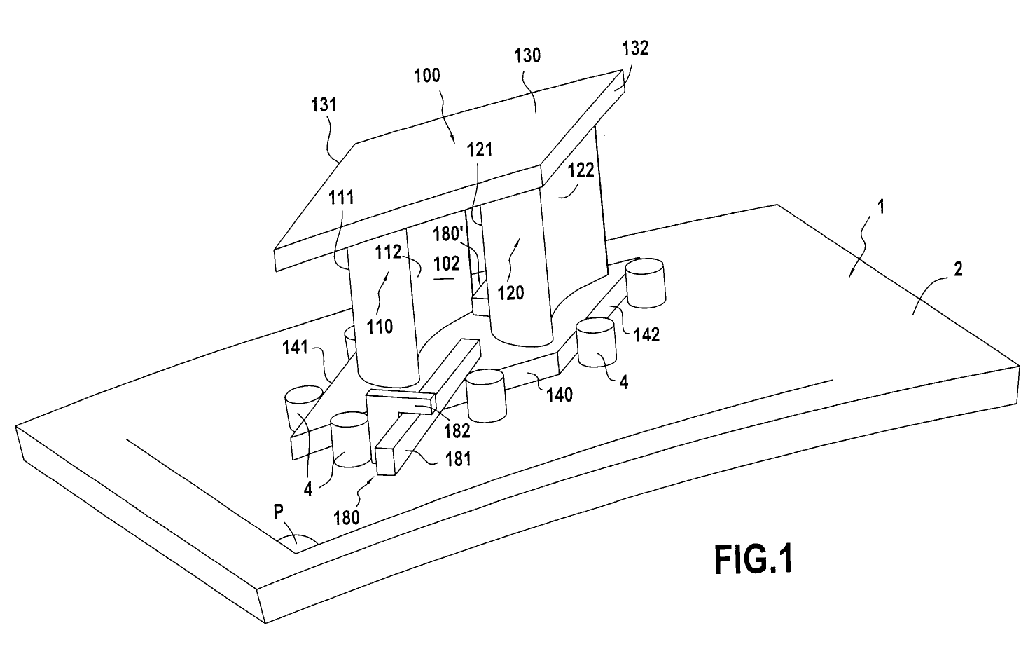

A nozzle sector, referred to as a “measured” sector in which it is desired to measure the flow sections, is described below with reference to FIGS. 1 to 3. Combining such sectors enables a nozzle to be built up, arranged around a nozzle axis.

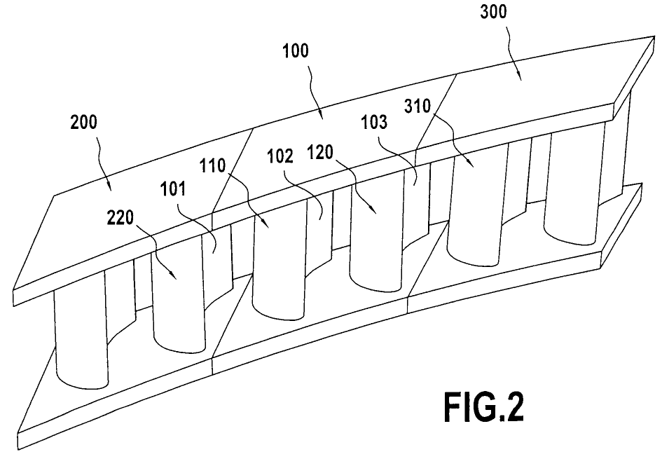

The nozzle sector 100 in FIG. 1 comprises two substantially parallel platforms 130 and 140. These platforms are substantially cylindrical in shape about the axis of the nozzle. These platforms 130, 140 have contact surfaces 131, 132, 141, 142 directed respectively towards the two nozzle sectors located on either side of the measured sector 100 (in the assembly relative position). The contact surfaces 131, 132, 141, 142 are designed to keep adjacent nozzle sectors in a contacting relative position, e.g. the sectors 100, 200, and 300 visible in FIG. 2.

The nozzle sector 100 also has two vanes 110, 120. Each of the vanes presents an airfoil with a suction side 111, 121 and a pressure side 112, 122. Since there are only two vanes in the sector 100, each of the vanes 110, 120 is an end vane. Thus, each of these vanes is placed facing an end vane of an adjacent nozzle sector in the assembly relative position. More precisely, the suction side 111 faces the pressure side 222 of the end vane 220 of the sector 200, and the suction side 122 faces the pressure side of the vane 310 of the sector 300.

Between the various vanes 220, 110, 120, 310, there are formed respective inter-vane passages 101, 102, 103. The passage 102 is formed between the vanes 110 and 120 of the sector 100. However the inter-vane passages 101 and 103 are each formed between one of the vanes (110 or 120) of the sector and a facing reference vane 220 or 310.

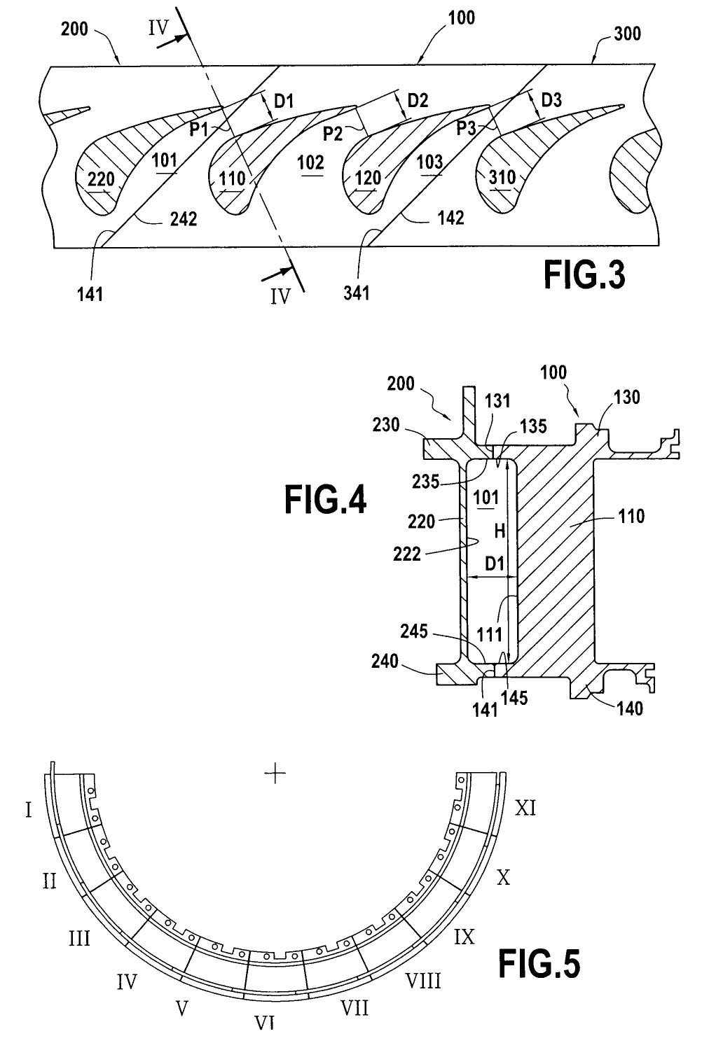

The flow sections are described with reference to FIG. 3. This figure is a section in a plane P perpendicular to the axes of the vanes and substantially halfway up them, showing the nozzle sectors 100, 200, 300 and in particular showing the reference vanes 220 and 310 (assuming that these vanes are solid vanes).

The section is shown after the numerical models of the various sectors involved have been reset in the assembly relative position. Here, the vanes 220 and 310 are the reference vanes.

The section view shows the sections of the various vanes 220, 110, 120, 310; the contact surfaces put into correspondence, 242, 141, 142, 341; and the inter-vane channels 101, 102, 103. By design, the nominal shape of the various channels is substantially the same.

As can be seen, in a given inter-vane channel, the distance between the vanes varies as a function of position along the channel. Normally, there exists a single channel plane in which this distance is at a minimum. Since the distance between the platforms 130, 140 is substantially constant, it is also in this plane that the flow section between the vanes is at a minimum, for a given inter-vane channel. This plane corresponds approximately to the planes P1, P2, P3 for the channels 101, 102, 103; the distances between the vanes in these sections are respectively D1, D2, and D3. It should be observed that in the method of the invention it is possible, advantageously, to optimize the position of the section planes P1, P2, P3 for each inter-vane channel, thereby making it possible to determine the plane of the inter-vane channel in which the flow section is indeed at a minimum.

FIG. 4 is a section showing two nozzle sectors 100 and 200 on the plane P1. It is a section view of the inter-vane channel 101 on the plane P1 where the distance between the vanes 220 and 110 is at a minimum. The (external) flow section of the nozzle sector 100, corresponding to this end, is equal to half the area of the empty space between the two vanes 110 and 220 and between the respective platforms of the sectors 100 and 200; it is thus equal substantially to half of the product H×D1.

The method of the invention for measuring the flow sections of a nozzle sector is described below.

During a first digitizing stage, a numerical model is generated of the nozzle sector and of its contact surfaces.

FIG. 1 shows an assembly bench 1 used for implementing this step of the method.

This assembly bench 1 comprises a rigid metal plate 2 having fastened thereon the measured nozzle sector 100. The plate 2 is cylindrical in shape and has the same curvature as the inside surface of the inner platform 140 of the sector 100.

The nozzle sector 100 is fastened to the plate by fastener means 180 and 180′, the means 180 including a retention bar 181 fastened by a hook 182 to hold the sector 100 on a first side, and the means 180′ comprise similar means but on the opposite side of the sector 100.

The position of the sector 100 is also determined in the plane of the plate by studs 4 fastened thereto.

The fastener means 180 and 180′ associated with the studs 4 hold the nozzle sector 100 in a position that is stationary relative of the plate 2.

It should be observed that the nozzle sector is fastened to the assembly bench in a position that preserves very large access to the portions of the nozzle sector that are to be measured. These portions are the facing surfaces of adjacent vanes, situated in the narrowest portions of the various inter-vane channels, and the contact surfaces.

FIG. 2 shows three nozzle sectors 100, 200, 300. They are placed in the assembly relative position by putting their respective contact surfaces into abutment.

In the measurement method of the invention, the measured nozzle sector is digitized, generally on its own, or at least without being specifically in its assembly position relative to the reference vanes. Digitizing it enables a three-dimensional numerical model thereof to be obtained. When the nozzle sector is digitized on its own, it is easier to obtain a complete model of the sector, i.e. including all of its outside surfaces.

In particular, measurement must include digitizing the contact surfaces of the nozzle sector. These contact surfaces 131, 132, 141, and 142 are the surfaces that serve to hold the sector relative to the two adjacent sectors in the assembly relative position.

Numerical models are also obtained of the reference vanes. For each reference vane, its model contains the assembly surfaces of the sector of which the vane forms the part. By way of example, these models may be extracted from the three-dimensional computer model of the nozzle (or only of the sector).

The numerical models of the reference vanes are reset (step c) of the method) relative to the numerical model of the sector. This operation is performed by putting the contact surfaces of the measured sector into correspondence with the contact surfaces of the reference vane sectors.

Finally, the flow sections of the measured sector are determined. This is performed as follows:

a flow section of a stream between two adjacent vanes is defined as being substantially equal to the minimum flow area available for the stream between them; and

the flow sections of the sector, when the sector has more than one vane, comprise firstly the flow section(s) between the one or more pairs of adjacent vanes of the sector; and secondly half of each flow section for the stream between an end vane of the sector and the reference vane set to face it.

In an implementation, a flow section for the stream between two adjacent vanes is determined on the basis of the shortest distance between them. The shortest distances between adjacent vanes in the three inter-vane channels 101, 102, 103 shown in FIG. 3 are the distances D1, D2, D3.

As explained in the introduction, by extension of the concept of a flow section, the distance D2 (for a flow section internal to the sector), the respective halves of the distances D1 and D3 (for the flow sections outside the sector) can be considered as being the flow sections of the nozzle sector.

A more exact definition of the flow sections nevertheless requires the flow sections to be determined in the form of areas.

Thus, to determine a flow section for the stream between two adjacent vanes, the area of the section of the empty space between the two vanes is measured in the plane substantially parallel to the axis of the vanes and in which the distance between the vanes is the shortest.

A first method of determining the values of the flow sections of the nozzle 100 is described below.

With reference more particularly to the inter-vane channel 101 (FIG. 4), the distance between the platforms 130 and 140 is constant, to a first approximation (these platforms being substantially cylindrical in shape and coaxial), and in one method of the invention for determining the flow sections of the sector, the value of the flow section between two adjacent vanes is the product of the shortest distance between the vanes, D1, multiplied by the distance H between the platforms.

Consequently, at the ends of the sector, the relative flow section of the sector in question (being measured), referred to as an “external” section, is equal to half the same product. It is thus specified:

S_{100/1}=½×S₁₀₁=½×D1×H

for the section relating to inter-vane channel 101 in FIG. 4.

For the channels 102 and 103, the flow sections relating to the sector 100 are respectively as follows:

S_{100/2}=S₁₀₂=D2×H (internal flow section); and

S_{100/3}=½ S₁₀₃=½×D3×H (external flow section)

The flow section that can be attributed to the nozzle sector 100 is given by:

S₁₀₀₀=S_{100/1}+S_{100/2}+S_{100/3}=½S₁₀₁+S₁₀₂+½S₁₀₃

Furthermore, because of the richness of the information present in the numerical model of the sector, other methods of determining values for the flow sections of the nozzle sector can be used.

By digitizing the planes of the sectors 100 and 200 it is possible to obtain the real flow section 101, and to determine the real positions of the four walls 111, 222, 135-235, 145-245 defining the sector, as shown in FIG. 4.

Determining the area of the portions of the plane P1 situated between these four walls can thus be done by measuring the real distance H between the platforms, measured for the channel under consideration between the two walls 135-235 and 145-245 of the platforms 130 and 140, and by multiplying this distance by the distance D1 between the walls 111 and 222 of the adjacent vanes 110 and 220.

Alternatively, it is possible to make even finer use of the information available in the numerical models to determine more exactly the flow area between adjacent vanes; various methods of calculating the flow area can be envisaged. For example, it can be observed that the portion of the plane P1 situated between the four above-mentioned walls is substantially a trapezoid (the walls of the vanes are parallel), and the area of this plane portion can be determined accordingly. This produces an even more accurate value for the flow section of the nozzle.

An implementation of the method of selecting an arrangement of sectors for a turbomachine nozzle is described below with reference to FIG. 5.

In a first step, the database of three-dimensional numerical models is created for a certain number of sectors. By way of example, it can thus be assumed that 100 numerical models are produced for 100 nozzle sectors that are numbered 1 to 100. Each three-dimensional model includes a representation of its contact surfaces, thus enabling each sector to be reset relative to the adjacent sectors.

A selection criterion is also set, for use in evaluating the quality of a given arrangement of sectors, and a preferred value is selected for this criterion. The criterion is a function of the flow sections of the sectors when in the assembly relative position in the arrangement. The following criterion is thus selected:

criterion=Σ_{arrangement}(Sᵢ−S₀)²

where Sᵢ is the flow section of sector i, and S₀ is the nominal flow section of a sector, and the sum applies to all of the sectors in the arrangement under consideration. (Other selections for the criterion are naturally possible).

The preferred value for this criterion is zero.

In the example under consideration, it is desired merely to optimize the selection of 11 sectors for occupying positions I to XI of a nozzle.

Amongst the sectors 1 to 100, consideration is given to all arrangements of sectors that enable a portion of a nozzle to be built up. Each arrangement is presented as a sequence of individual references for the sectors in the arrangements, and ordered to match the positions I to XI, for example one such arrangement is the sequence (28-4-90-54-43-91-3-11-35-66), in which, for example, sector No. 28 occupies the position I and sector No. 66 occupies the position XI.

In each of the possible arrangements of the one hundred sectors, and by working on the sections of the numerical models as reset in this way, as explained in greater detail above, the flow sections are determined for all of the sectors. Naturally, in order to determine the external flow sections of the vanes situated at the end positions in a given arrangement, the reference vanes are taken into account using the numerical model for a vane having nominal dimensions and reset relative to the end sector.

The values for the above-mentioned criterion are then determined for all of the different arrangements that are evaluated.

The arrangement that is used is the arrangement in which the selection criterion has the value that is closest to the desired value.

What is claimed is:

1. A method of measuring the flow sections of a turbomachine nozzle sector relative to two reference vanes, said sector having at least one vane, the method comprising the following steps:
a) producing a three-dimensional numerical model of the sector by digitizing;
b) providing the numerical models of each of two reference vanes;
c) resetting the numerical models of the two reference vanes at the ends of the sector in the assembly relative position in the nozzle; and
d) determining the flow sections of the sector from the sections of the numerical models of the sector and of the reference vanes;
wherein:
the nozzle sector has contact surfaces and is positioned relative to the adjacent nozzle sectors by putting said contact surfaces into abutment;
the numerical models of the sector and of the reference vanes include modeling the contact surfaces involving in putting them into their assembly relative position; and
step c) of resetting the numerical models of the reference vanes relative to the numerical model of the sector is performed by putting said contact surfaces into correspondence.

2. A method according to claim 1, wherein the numerical model of at least one of the reference vanes is obtained by digitizing at least one other nozzle sector.

3. A method according to claim 1, wherein the numerical model of the reference vanes provided in step b) is a theoretical numerical model of the vanes.

4. A method according to claim 1, wherein digitizing step a) is performed with the help of contactless optical measurement means.

5. A method according to claim 1, wherein, for a stream flow section between two adjacent vanes being substantially the minimum stream flow area therebetween, and for the flow sections of the sector being firstly half of each of the stream flow sections between an end vane of the sector and the reference vane reset facing it, and secondly, when the sector has more than one vane, the or each stream flow sections between the pair(s) of adjacent vanes of the sector; in order to determine the stream flow section between two adjacent vanes the area of the section of the empty space between the two vanes is measured in the plane substantially parallel to the axis of the vanes in which the distance between the vanes is the shortest.

6. A method according to claim 1, wherein, for a stream flow section between two adjacent vanes being substantially the minimum stream flow area therebetween, and the flow sections of the sector being firstly half of the stream flow sections between an end vane of the sector and the reference vane reset facing it, and secondly, when the sector has more than one vane, the stream flow section(s) between the pair(s) of adjacent vanes of the sector; a stream flow section between two adjacent vanes is determined on the basis of the shortest distance therebetween.

7. A method of selecting an arrangement of sectors for a turbomachine nozzle, wherein the method comprises the steps of:
A) creating a database of three-dimensional numerical models of the nozzle sectors by digitizing;
B) setting a criterion for selecting an arrangement of sectors and setting a desired value for said criterion, the criterion being a function of the flow sections of the sectors in their assembly relative positions in the arrangement;
C) for the various arrangements that are evaluated, determining the relative positions of the sectors assembled together by performing virtual assembly; then evaluating the flow sections of the sectors with the help of the method according to claim 1, using as reference vanes for any one sector the facing vanes of the sectors that are adjacent in the arrangement, and on the basis of the resulting flow sections, determining the value of the selection criterion for the arrangement being evaluated; and
D) retaining the arrangement for which the selection criterion has the value closest to the desired value.

8. A method according to claim 7, wherein, in step C), at least one evaluated arrangement is the combination of an arrangement selected by the method plus another sector or another arrangement selected with the help of the method.

9. A method according to claim 7, wherein, in step A), the database used for the method contains sectors coming from a single nozzle.

10. A method according to claim 7, wherein, in step A), the database used for the method contains sectors coming from at least two different nozzles.
